(19) United States
(12) Patent Application Publication
(10) Pub. No.: US 2026/0016646 A1
(43) Pub. Date: Jan. 15, 2026

(54) QUANTUM MEMORY-INTEGRATED FIBER

(71) Applicants: Massachusetts Institute of Technology, Cambridge, MA (US); Cambridge Enterprise Limited, Cambridge (GB)

(72) Inventors: Yong Hu, Cambridge, MA (US); Jesús Arjona Martínez, London (GB); Ryan A. Parker, Victoria (AU); Mete Atature, Cambridge (GB); Dirk R. Englund, Brookline, MA (US)

(21) Appl. No.: 18/646,915

(22) Filed: Apr. 26, 2024

Related U.S. Application Data
(60) Provisional application No. 63/499,220, filed on Apr. 29, 2023.

(51) Int. Cl. G02B 6/42; G02B 6/02; G02B 6/30

(52) U.S. Cl. CPC G02B 6/4239; G02B 6/4204; G02B 6/424; G02B 6/02328; G02B 6/305

(57) ABSTRACT

Several techniques for coupling a waveguide and a fiber are disclosed. These techniques allow the realization of several important metrics. These techniques achieve high optical coupling efficiency (η). Further, these techniques allow simple scaling to large numbers of waveguides coupled to as many fiber modes. Additionally, these techniques allow application of microwave fields for quantum memory spin control. These techniques may utilize a photo-polymerizable resin to stabilize the interface between the fiber and the waveguides. The resin may be UV curable or may be a 2 photon polymerizable (2PP) resin.

This application claims priority to U.S. Provisional Patent Application Ser. No. 63/499, 220, filed Apr. 29, 2023, the disclosure of which is incorporated herein by reference in its entirety.

### Statement Regarding Federally Sponsored Research or Development

This invention was made with government support under FA9550-20-1-0105 awarded by the Air Force Office of Scientific Research, EEC1941583 awarded by the National Science Foundation, and W911NF-21-1-0325 awarded by the U.S. Army Research Office. The government has certain rights in the invention.

### STATEMENT REGARDING OTHER SPONSORED RESEARCH OR DEVELOPMENT

The project leading to this application has received funding from the European Research Council (ERC) under the European Union's Horizon 2020 research and innovation programme (grant agreement No 884745).

### BACKGROUND

Atom-like solid-state quantum memories play a central role in a number of quantum technologies, from quantum sensing to computing to communications. Many of the leading quantum systems have recently been realized in waveguides of their host material, including quantum dots (QDs) in III-V semiconductors, color centers in diamond or silicon carbide or Zno or silicon, or rare earth ions in crystalline or amorphous host materials.

However, an outstanding challenge is to develop methods for optical coupling between these waveguides and optical fiber that achieve the desired objectives. Specifically, high optical coupling efficiency (η) is desirable, as is the ability to accommodate simple scaling to large numbers of waveguides coupled to the same number of single-mode fibers. Finally, it is advantageous if the optical coupling allowed the application of microwave fields and strain tuning for quantum memory spin control.

Therefore, it would be beneficial if there were a system and method of optically coupling these waveguides to an optical fiber that achieves these objectives.

### SUMMARY

Several techniques for coupling a waveguide and a fiber are disclosed. These techniques allow the realization of several important metrics. These techniques achieve high optical coupling efficiency (η). Further, these techniques allow simple scaling to large numbers of waveguides coupled to as many single-mode fibers. Additionally, these techniques allow application of microwave fields for quantum memory spin control. These techniques may utilize a photo-polymerizable resin to stabilize the interface between the fiber and the waveguides. The resin may be UV curable or may be a 2 photon polymerizable (2PP) resin.

According to one embodiment, a method of coupling an optical fiber to a waveguide is disclosed. The method comprises providing a single-mode fiber and a waveguide having a tapered end; contacting the optical fiber to the waveguide to produce an interface; and packaging the interface using a photo-polymerizable adhesive. In some embodiments, an end of the optical fiber contacts the tapered end of the waveguide. In certain embodiments, the photo-polymerizable adhesive is cured by transmitting a curing light through the optical fiber. In certain embodiments, the curing light utilizes ultraviolet light. In certain embodiments, the photo-polymerizable adhesive comprises a two-photon polymerizable (2PP) resin, and the curing light utilizes infrared light. In some embodiments, the tapered end of the waveguide has a width of between 40 nm and 60 nm. In some embodiments, the photo-polymerizable adhesive has an index of refraction within 10% of the index of refraction of the optical fiber. In some embodiments, the waveguide comprises a diamond waveguide.

According to another embodiment, a method of scalably coupling an optical fiber to a waveguide chiplet is disclosed. The method comprises providing a fiber-bundle having a plurality of cores or hollow cores, and a waveguide chiplet having a plurality of waveguides; coupling each core or hollow core of the fiber-bundle to a tapered end of a respective waveguide of the waveguide chiplet to produce a plurality of interfaces; and packaging the plurality of interfaces using a photo-polymerizable adhesive. In some embodiments, the fiber-bundle comprises a plurality of cores, wherein each core is tapered and each tapered core is coupled to a respective waveguide. In some embodiments, an end of each core is coupled to the tapered end of the respective waveguide. In certain embodiments, the photo-polymerizable adhesive is cured by transmitting a curing light through the optical fiber. In certain embodiments, the photo-polymerizable adhesive comprises a 2PP resin, and the curing light comprises infrared energy. In some embodiments, the fiber-bundle has a plurality of cores surrounded by a cladding, and the method further comprises selectively etching the cores such that ends of the cores are recessed from the cladding prior to the coupling. In some embodiments, the method further comprises etching a CMOS device to form an etched region; and disposing the waveguide chiplet in the etched region, wherein the tapered ends of the waveguides overhang an edge of the CMOS device. In certain embodiments, the method comprises disposing a microwave antenna on a top surface of the CMOS device.

According to another embodiment, a packaged device is disclosed. The packaged device comprises a CMOS device having an etched region; a waveguide chiplet, comprising a plurality of waveguides, each having a tapered end, disposed in the etched region, wherein the tapered ends overhang an edge of the CMOS device; and a fiber comprising a plurality of cores or hollow cores; wherein a respective tapered end is coupled to an end of a respective core or hollow core to form a plurality of interfaces; wherein the CMOS device, the waveguide chiplet and the plurality of interfaces are disposed in a package having a plurality of leads. In some embodiments, the packaged device comprises a microwave antenna disposed on a surface of the CMOS device, and wherein RF signals are passed to the microwave antenna via one or more of the plurality of leads. In some embodiments, the tapered ends are coupled to the respective cores or hollow cores using a photo-polymerizable adhesive. In some embodiments, the packaged device comprises a spring to stabilize the interfaces between the tapered ends and the respective cores or hollow cores.

### BRIEF DESCRIPTION OF THE DRAWINGS

For a better understanding of the present disclosure, reference is made to the accompanying drawings, in which like elements are referenced with like numerals, and in which:

FIG. 1A shows a schematic of a link between a single mode fiber and a single waveguide, where the mode at various locations along the photon propagation path is shown;

FIG. 1B shows a diamond-fiber coupled device with an adiabatic link;

FIG. 1C is a simulation highlighting the sensitivity of the positioning of quantum emitter in the waveguide to the coupling efficiency;

FIGS. 2A-2F show the process flow to couple a single mode fiber to a waveguide or a quantum microchiplet according to one embodiment;

FIG. 3 shows a schematic of the coupling of a single-mode waveguide to a single-mode fiber according to another embodiment; FIG. 4 shows the coupling of FIG. 3 with a resin application to stabilize the fiber-waveguide interface;

FIGS. 5A-5B show the cross-sectional areas of the ends of the waveguide and fiber used in FIGS. 3-4, respectively;

FIG. 6 shows various parameters for the waveguide with resin and the fiber as a function of waveguide width;

FIG. 7 shows various parameters for the waveguide and the fiber as a function of waveguide width;

FIG. 8 shows representative simulation results for the TE mode of the cross-sectional areas of the waveguide, the waveguide with resin and the fiber;

FIG. 9 shows the scalability of the present techniques according to one embodiment;

FIGS. 10A-10B show a schematic figure for a scalable fiber-waveguide coupling design according to one embodiment;

FIG. 11 shows another approach to coupling waveguides and multiple cores;

multiple

FIGS. 12A-12D show approaches for evanescently coupling the waveguide and the core; and

FIG. 13 shows a technique to expose the quantum emitters to a photodiode and magnetic fields.

### DETAILED DESCRIPTION

The disclosure is directed toward various systems and methods of coupling a waveguide to a fiber. Several different approaches are described.

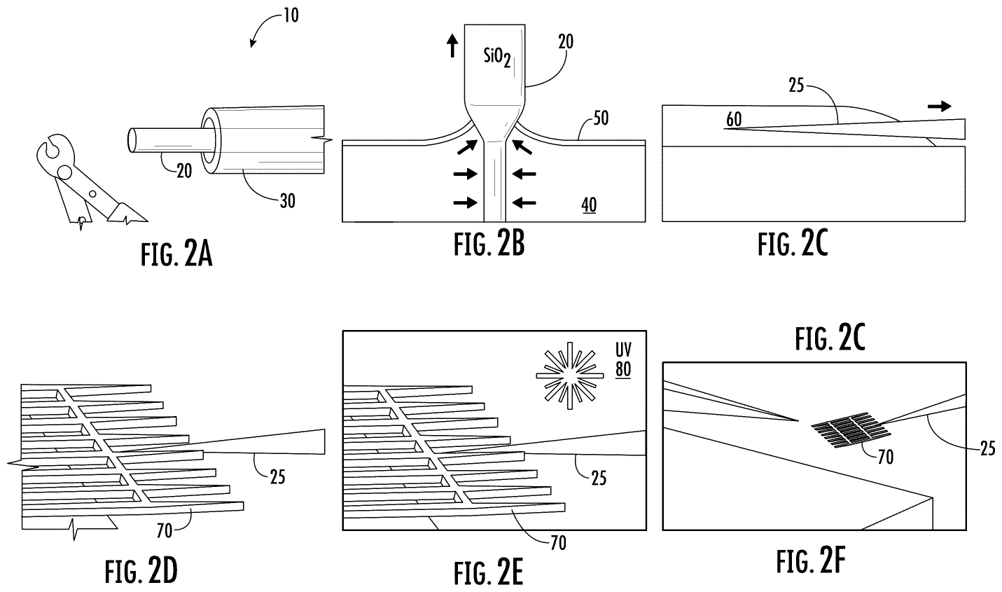

According to the first embodiment, the fiber is tapered before being affixed to the waveguide. FIGS. 2A-2F show this process.

First, as shown in FIG. 2A, the fiberoptic cable 10 is cleaved and a portion of the cladding 30 at the end of the fiberoptic cable 10 is stripped, exposing the core 20. Next, as shown in FIG. 2B, dynamic meniscus etching is used to conically taper the core 20. In some embodiments, the core 20 is lifted out of a solution 40 of 40% hydrofluoric acid, with a thin layer 50 of o-xylene on top of the solution 40. This thin layer 50 may be used to limit the fluorine vapor that is produced. This action creates a conically tapered core 25.

As shown in FIG. 2C, the conically tapered core 25 is then drawn through a photo-polymerizable adhesive 60, such as NA086H or others. In certain embodiments, the photo-polymerizable adhesive 60 may be selected based on its index of refraction. For example, the index of refraction of the adhesive may be close to that of the core 20, such as within 20%. The conically tapered core 25 then contacts the adiabatically tapered region of a waveguide 70, which may be part of a quantum microchiplet, as shown in FIG. 2D. The point at which the conically tapered core 25 contacts the adiabatically tapered region of the waveguide 70 may be referred to as the interface. Next, as shown in FIG. 2E, the interface is exposed to a curing light 80. This causes the adhesive to be photo-polymerized through exposure to the curing light 80. In the case of NAO86H, that curing light 80 may be ultraviolet light. In another embodiment, the photo-polymerizable adhesive 60 may be a two photon polymerizable (2PP) resin, which is cured using two photons having infrared energy. In this embodiment, the curing light 80 may be infrared light. Afterwards, the coupling is complete, and the conically tapered core 25 and waveguide 70 may be easily moved, as shown in FIG. 2F. The assembled device may then be integrated into a quantum repeater network, or another system.

This approach achieves high optical coupling efficiency (η). In fact, using this approach and a waveguide having a tapered end of less than 60 nm in width, greater than 80% of the dipole radiation field may be coupled to the waveguide mode and transferred with near unity efficiency to the fiber mode. Experimentally, transfer efficiencies of 57(6)% are readily achieved. This notation implies a value of 57% with an uncertainty or error of 6%.

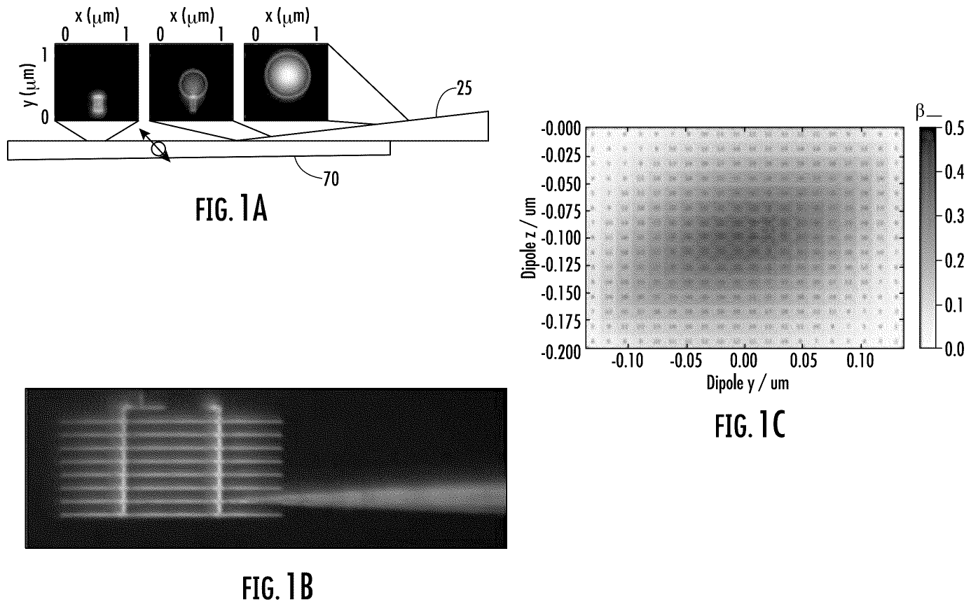

FIGS. 1A-1C show the performance characteristics of this optical coupling. FIG. 1A shows the side view of the conically tapered core 25 attached to the waveguide 70 of a quantum microchiplet. A single light-matter interface, located within the waveguide, is highlighted. The mode at various locations along the photon propagation path are shown, highlighting the adiabatic link. FIG. 1B shows the physical embodiment of this coupling. FIG. 1C shows simulations highlighting the sensitivity of the positioning of the light-matter interface within the waveguided mode. The two axis (y, z) represent the location of quantum emitters in the waveguide, wherein the waveguide is along the x direction. Here, photon collection is only considered through one of the two waveguide ports, and, as such, a coupling efficiency from one end of the waveguide to the tapered fiber of 0.5 corresponds to perfect mode transfer from the emitter into the waveguide mode.

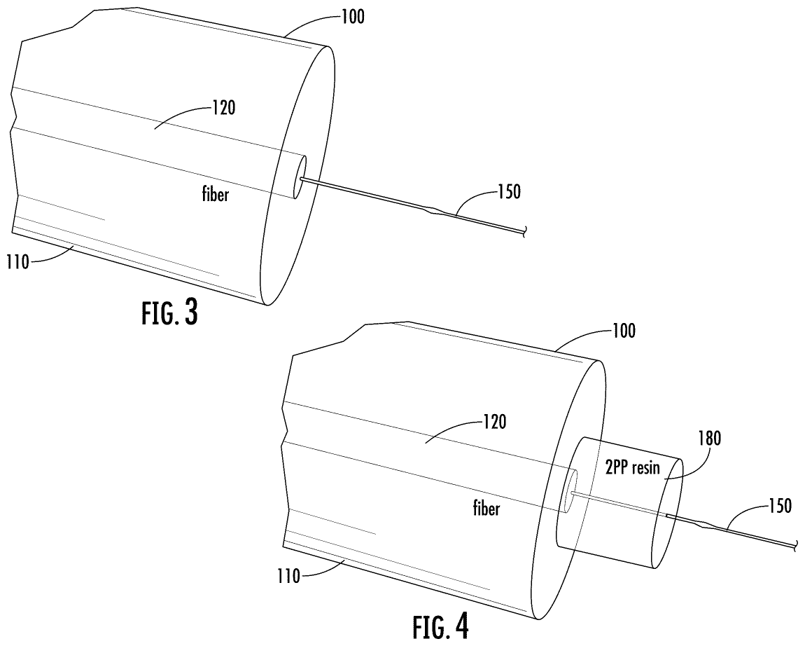

FIGS. 3-4 and 5A-5B show a second embodiment. In this method, the waveguide is attached to the core in an end-to-end configuration. In other words, unlike FIGS. 1A-1C and 2A-2F, the end of the core is directly affixed to the end of the waveguide.

FIG. 3 shows a fiber 100 having a cladding 110 and a core 120. A waveguide 150 is also shown. In this embodiment, the cladding 110 is not stripped away from the core 120. Further, the end of the core 120 is defined as the surface that is exposed in the axial direction. The end of the core 120 may be planar and perpendicular to the axial direction. The outer radial surface of the core 120, which is surrounded by the cladding 110 and extends in the radial direction, is not contacted by the waveguide 150. Further, the waveguide 150 may have a height, a width and a length. The area that contacts the end of the core 120 is defined by the height and the width of the waveguide. Again, the waveguide 150 does not contact the core 120 along its outer radial surface. Further, the end of the waveguide 150 may be tapered in the width direction. The end of the waveguide 150 is pressed against the end of the core 120 to form an interface.

As shown in FIG. 4, after the end of the waveguide 150 is aligned and pressed against the end of the core 120, a photo-polymerizable resin 180 is disposed near the interface between these components. In some embodiments, the photo-polymerizable resin 180 may be cured using ultraviolet light. In other embodiments, the photo-polymerizable resin 180 may be a two photon polymerizable (2PP) resin, which is cured using two photons having infrared energy. In either embodiment, the curing light is transmitted through the core 120 to the photo-polymerizable resin 180 to cure the resin. In other words, the curing light enters the opposite end of the fiber 100 and is transmitted through the core 120 to the interface, where it serves to cure the resin. This serves to stabilize the fiber-waveguide interface after the fiber 100 is aligned to the tapered end of the waveguide 150.

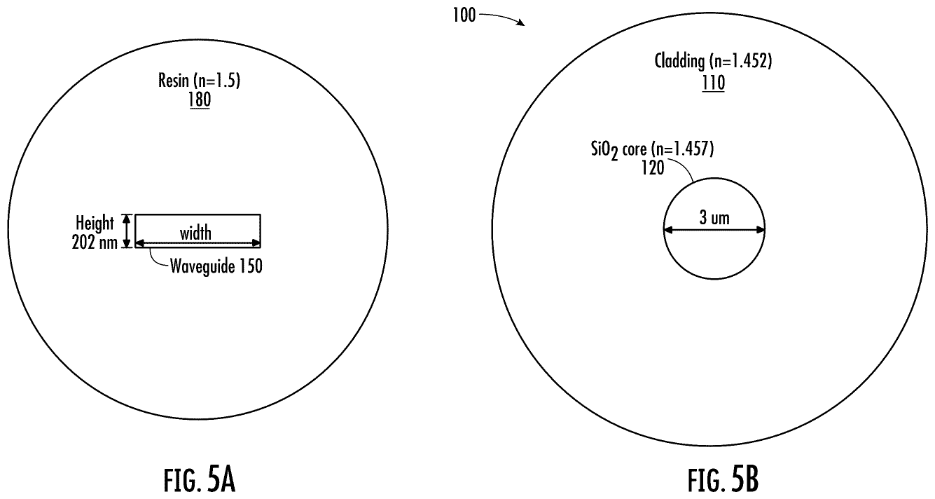

FIGS. 5A-5B show the ends of the waveguide 150 and the fiber 100, respectively. As shown in FIG. 5A, the waveguide 150 has a height, which typically remains constant, and a width. The height may be standardized, such as between 100 nm and 500 nm, such as about 202 nm. It is the width that is tapered in this embodiment. In some embodiments, the width of the waveguide 150 may be about 300 nm before tapering. Further, the waveguide 150 is surrounded by the photo-polymerizable resin 180. The resin may have an index of refraction (n) that is roughly the same as the core 120 of the fiber 100. In some embodiments, the index of refraction of the resin is within 10% of the index of refraction of the core 120. In certain embodiments, the resin may have an index of refraction of about 1.5. The diameter of the resin may be several times larger than the dimension of the waveguide 150, such as between 3 and 6 μm, although other dimensions may be used. In some embodiments, the diameter of the resin may be roughly equal to the diameter of the core 120. As shown in FIG. 5B, the fiber 100 includes a core 120 having a diameter of about 3 μm, surrounded by a cladding 110. The core 120 may be SiO₂. The cladding 110 surrounding the core 120 may have a diameter of about 125 μm. The indices of refraction of the core 120 and the cladding 110 may be about 1.45. In some embodiments, the index of refraction of the cladding 110 is slightly lower than the index of refraction of the core 120. In one specific embodiment, the indices of the core 120 and the cladding 110 are 1.457 and 1.452, respectively.

As noted above, the end of the waveguide 150 may be tapered prior to adhesion to the core 120. The taper is performed in the width dimension, while the height may remain unchanged. In one embodiment, the starting width of the waveguide 150 is about 300 nm and it is tapered to its final width over a distance of between 9 and 15 μm. In certain embodiments, the taper may be linear along the waveguided direction.

The end of the waveguide 150 is adhered to the core 120. In certain embodiments, the center of the waveguide (as defined in the width and height directions) is aligned with the center of the core 120. In certain embodiments, the distance between the center of the waveguide 150 and the center of the core 120 is less than 1 μm. Note that any uncured resin may be removed using isopropyl alcohol.

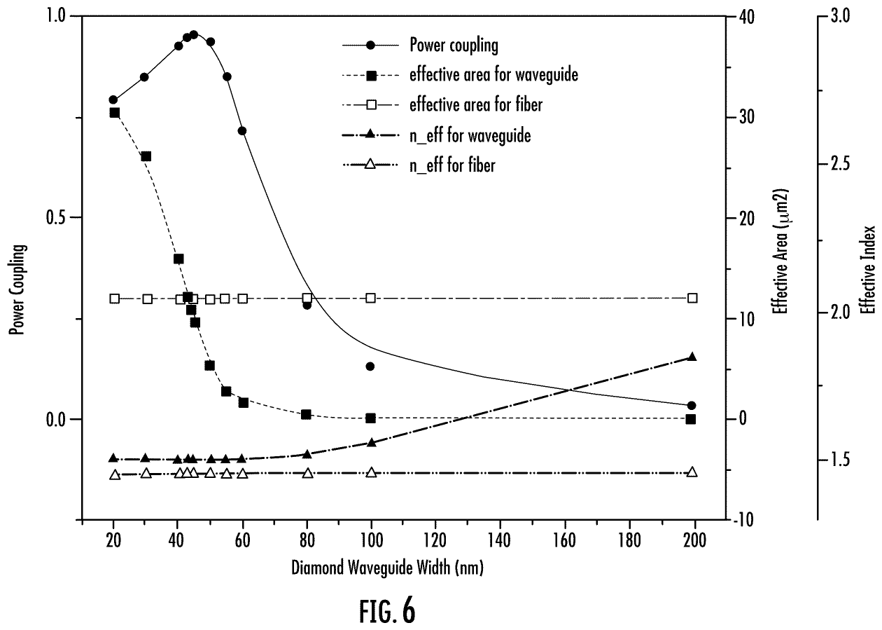

FIG. 6 shows simulation results for a waveguide 150 (surrounded by resin) coupling at 620 nm. The horizontal axis represents the width of the tapered end of the waveguide 150. The width is swept from 20 nm to 200 nm. These results are simulated using a finite-difference eigenmode (FDE) solver with the height of the waveguide 150 set to 202 nm and the refractive index of the resin set to 1.5. The fiber 100 is as described in FIG. 5B. The left vertical axis shows the simulation results for the power coupling efficiency between the waveguide 150 and fiber 100 at different widths of the tapered end of the waveguide 150. Note that the terms “power coupling efficiency” and “transfer efficiency” are used interchangeably and are synonymous. Note that the power coupling efficiency reaches a peak value of about 95.6% at about 45 nm. The first right vertical axis shows the simulation results for the effective area of the waveguide 150 and fiber 100 at different waveguide widths. Effective area is based on the ratio of a mode's total energy density per unit length and its peak energy density, wherein larger values are desirable. Note that the effective area of the waveguide 150 varies as a function of the width at the tapered end, wherein the effective area decreases as the width at the tapered end increases. The effective area of the fiber 100 is unchanged, as its core and cladding dimensions are fixed. Note that power coupling is maximized where the effective area of the waveguide 150 is roughly equal to the effective area of the fiber 100. At a width of 45 nm, the effective area for the waveguide (with resin) and fiber is 9.73 μm² and 11.98 μm², respectively. The second vertical axis shows the effective index of refraction (n_eff) of the waveguide 150 and fiber 100 at different waveguide widths. Note that the index of refraction of the waveguide 150 increases for larger widths of the tapered end. For the 45 nm width, the effective index for the waveguide (with resin) and fiber is 1.50 and 1.45, respectively. Note that this simulation was performed assuming a diamond waveguide, but waveguides using other materials may also be used.

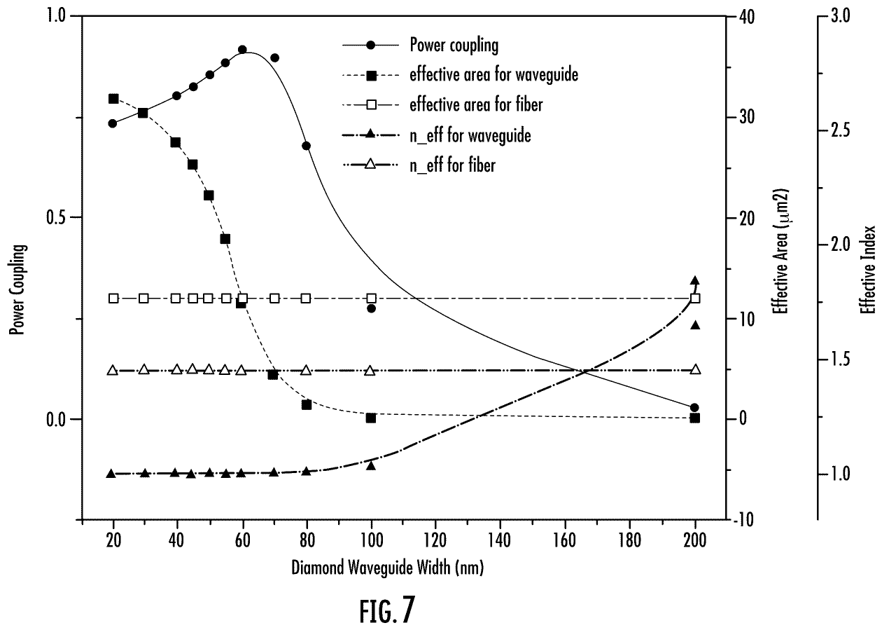

FIG. 7 is similar to FIG. 6, except, in this simulation, the resin is not present. This figure shows the changes in coupling parameters resulting from the application of the resin. Note that because the resin is not present, the effective index of refraction of the waveguide 150 increases much more quickly at large widths than it did in FIG. 6. Further, the power coupling peak shifts slightly to the right without the resin. Specifically, when the resin is removed, the simulation results show that the highest coupling efficiency of 91.9% is achieved when the tapered end of the waveguide 150 has a width of 60 nm. When the width of the tapered end of the waveguide 150 is 60 nm, the effective area for the waveguide and fiber is 11.7 and 11.98 μm², respectively. At this width of the tapered end of the waveguide 150, the effective index for waveguide 150 and fiber 100 is 1.00 and 1.50, respectively.

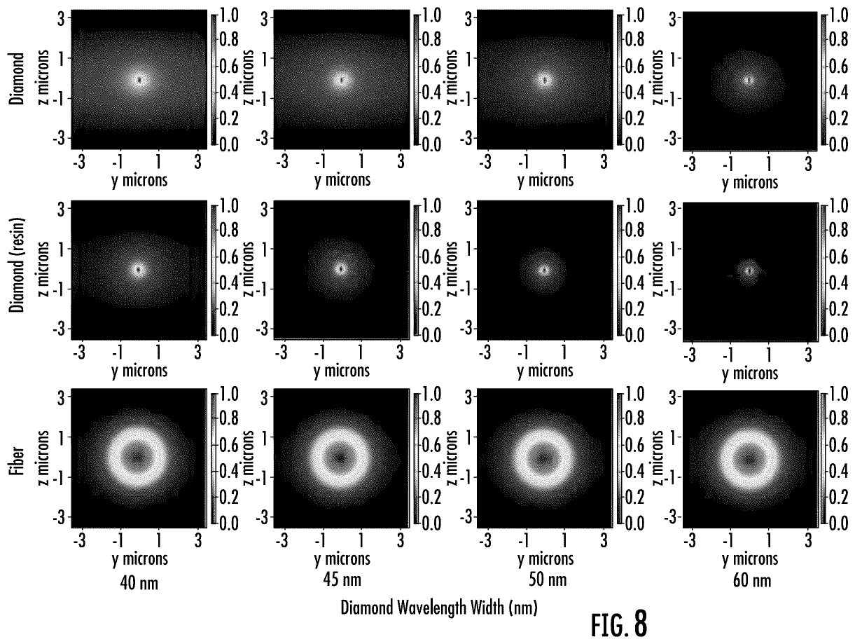

FIG. 8 shows the representative simulation results for the TE mode profile (at 620 nm) of the cross-sectional areas of waveguide, waveguide with resin and fiber at the fiber-waveguide interface. The width of the tapered end of the waveguide is swept from 40 nm to 60 nm during the simulation. The color bar represents the normalized electric field. Note that the electric field is unchanged in the fiber, since its dimensions are constant. However, the electric field in the waveguide varies as the width of the waveguide is changed. Again, while FIGS. 6-8 illustrate diamond waveguides, other materials may be used.

These two coupling techniques allow various scalable configurations to be created.

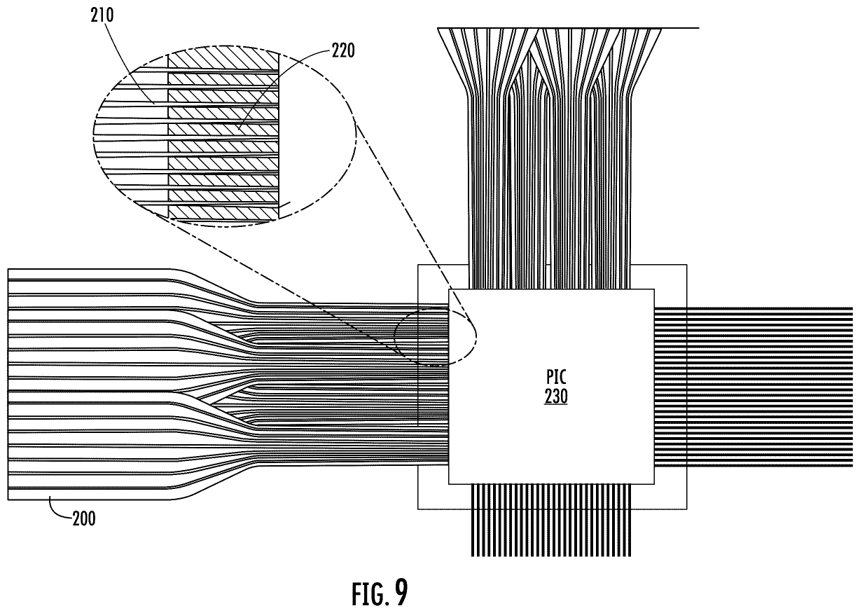

In one embodiment, the coupling techniques shown in FIGS. 1A-1C and 2A-2F are used to address simple scaling to large numbers of waveguides coupled to as many single-mode fibers, and application of microwave fields for quantum memory spin control. FIG. 9 shows how a multi-cored fiber-bundle 200, comprising a plurality of conically tapered cores 210, can be scalably packaged to a large series of waveguides 220, each interfaced with a single photonic-integrated chip (PIC) 230 using only the packaged adiabatic links described in FIGS. 1A-1C and 2A-2F. More specifically, FIG. 9 shows a concept drawing illustrating how to integrate multiple packaged fiber links to a series of quantum microchiplets, each coupled to a single photonic integrated circuit (PIC) 230. A multi-cored fiber-bundle 200, with each core 210 individually tapered, is used as the multi-channeled input-output port for the PIC 230. The fabrication tolerance of the packaging scheme ensures that small errors in conical taper length and angle do not inhibit the performance of the chip. Such a device allows for large-scale integration of multiple long-distance fiber-based communication channels, with photon-routing and MW delivery being facilitated through the hybrid diamond-PIC interface packaged to a scalable fiber bundle.

While FIG. 9 shows the coupling techniques of FIGS. 1A-1C and 2A-2F, it is understood that the coupling technique shown in FIGS. 3-4 and 5A-5B may also be used to couple the multi-cored fiber-bundle 200 to the large series of waveguides 220.

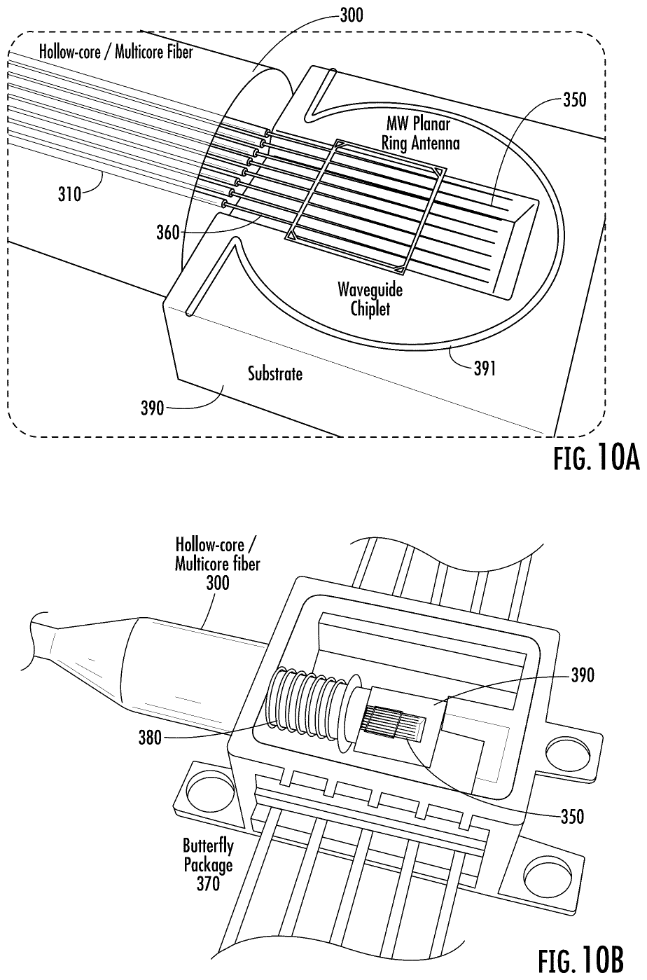

FIGS. 10A-10B show a scalable coupling design that utilizes the technique described in FIGS. 3-4 and 5A-5B. FIG. 10A shows the waveguide interfaced to the multicore fiber, while FIG. 10B shows how that interface may be packaged.

This embodiment relies on hollow-core and multicore fibers 300, which include a plurality of cores 310. A waveguide chiplet 350, which includes a plurality of waveguides 360 equal to the number of cores 310, is designed using the techniques and simulation results described above. Thus, as described above, each waveguide 360 includes a tapered end. The waveguide chiplet 350 is disposed on an etched substrate 390, such that the tapered ends of the waveguides 360 overhang the edge of the substrate 390. Further, the top surface of the substrate 390 may be etched such that the waveguide chiplet 350 fits within the etched region, as shown in FIG. 10A. In certain embodiments, the substrate 390 also includes a microwave (MW) antenna 391 for applying a microwave field. The microwave antenna 391 may be disposed on the top surface of the substrate 390, around the etched region in which the waveguide chiplet 350 is positioned. In certain embodiments, the microwave antenna 391 may be a planar ring antenna.

Each core 310 in the hollow-core or multicore fiber 300 is then aligned with a respective tapered end of a waveguide 360 of the waveguide chiplet 350. Although not shown, in some embodiments, the photo-polymerizable resin is applied to the interface between the cores 310 and the respective tapered ends of the waveguides 360. As explained above, this resin is cured by transmitting light through the multicore fiber 300. As shown in FIG. 10B, the fiber-waveguide coupled devices may then be assembled in a butterfly package 370. These butterfly packages are well known in the industry. In some embodiments, a spring 380 may be used to stabilize the interface between the cores 310 and waveguides 360. In some embodiments, the friction force between fiber end and substrate 390, which may be a CMOS device, may be used to maintain the position. The connections to the butterfly package, also referred to as leads, may be used to provide RF signals to the microwave antenna 391 and DC voltages.

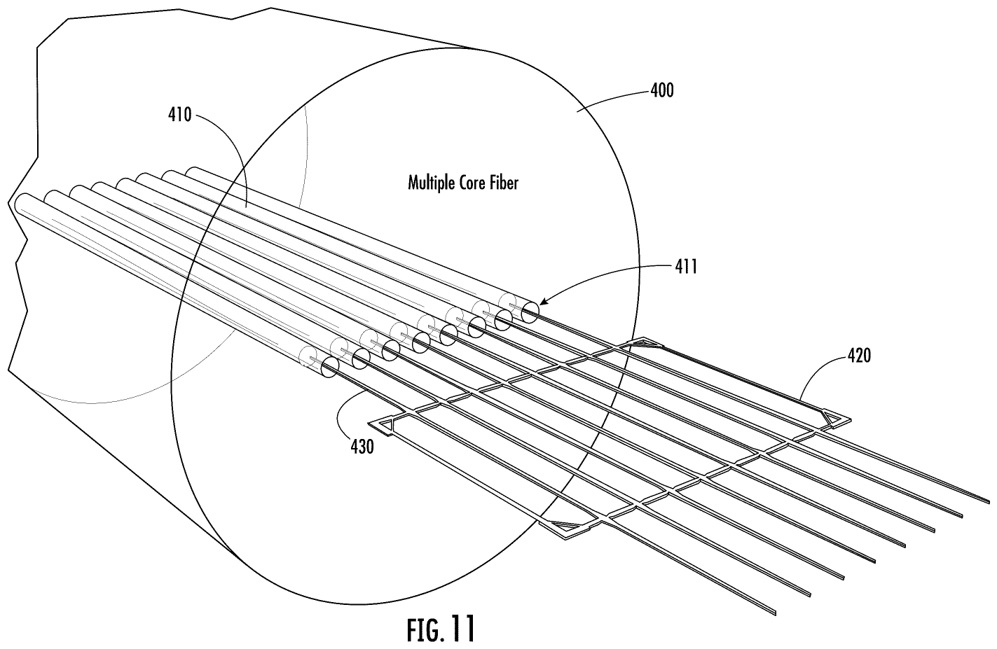

FIG. 11 shows another embodiment that utilizes the method shown in FIGS. 3-4 and 5A-5B. In this embodiment, the fiber cable 400 may include one or more cores 410, which may be made from SiO₂. A plurality of waveguides 430 may be part of a waveguide chiplet 420. The waveguides 430 have tapered ends, as described above. Further, the cores 410 are selectively etched such that they are recessed from the end of the fiber cable 400. Photo-polymerizable resin may then be disposed in each of these recesses 411, and the tapered ends of the waveguides 430 are each pressed against a respective core 410 to form an interface. As described above, curing light may be transmitted through the cores 410 and serve to cure the resin, stabilizing the interfaces.

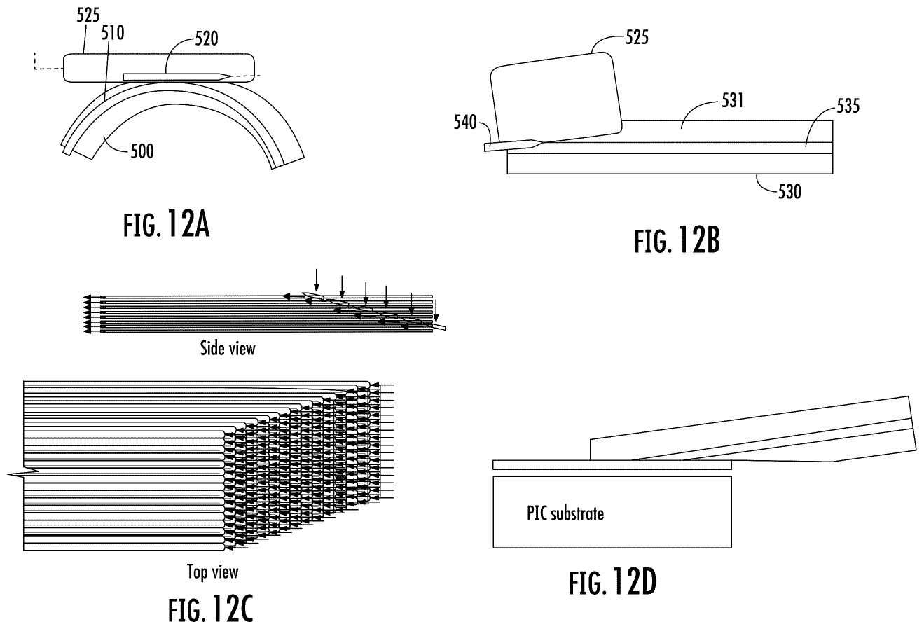

FIGS. 12A-12D show other embodiments for evanescently coupling that do not utilize a photo-polymerizable resin. In FIG. 12A, the fiber 500 is bent, and the rounded section is polished to expose the core 510, wherein a portion of the exposed core is flattened. This may be referred to as a D-cut, as the cross-section of the polished portion of the core 510 resembles the letter “D”. The waveguide 520 is then placed on the exposed and polished core. A resin 525, such as polymethyl methacrylate (PMMA) with an index of refraction of about 1.5, is then applied to the waveguide-fiber interface. The fiber 500 and the waveguide 520 are now evanescently coupled.

FIG. 12B shows one fiber, while FIG. 12C shows a fiber array. In FIG. 12B, the end of the fiber 530 is polished at a slant to form a linearly tapered end, which is defined as an end having a flat surface that is not perpendicular to the axial direction. In some embodiments, both the cladding 531 and the core 535 are polished to form this linearly tapered end. This linearly tapered end is then pressed against the waveguide 540. Again, a resin 525, such as PMMA may be applied to the fiber-waveguide interface. This linearly tapered end allows for coupling to the waveguide 540 anywhere in-plane. Again, the fiber 530 and the waveguide 540 are now evanescently coupled. FIG. 12C shows top and side views of an array of the fibers 530 with the linearly tapered ends evanescently coupled to a plurality of waveguides 540.

FIG. 12D shows that the linearly tapered end of the fiber 530 enables coupling to waveguides that are in any in-plane position on a photonic integrated circuit (PIC).

Note that the waveguides in any of the previous embodiments may be diamond waveguides containing color centers such as tin vacancies (SnV), silicon vacancies (SiV), nitrogen vacancies (NV), or germanium vacancies (GeV). The same or similar techniques equally apply to other solid-state waveguide host materials, such as color centers in silicon carbide (SiC), silicon (Si), gallium nitride (GaN), rare earth-doped crystals and quantum dots.

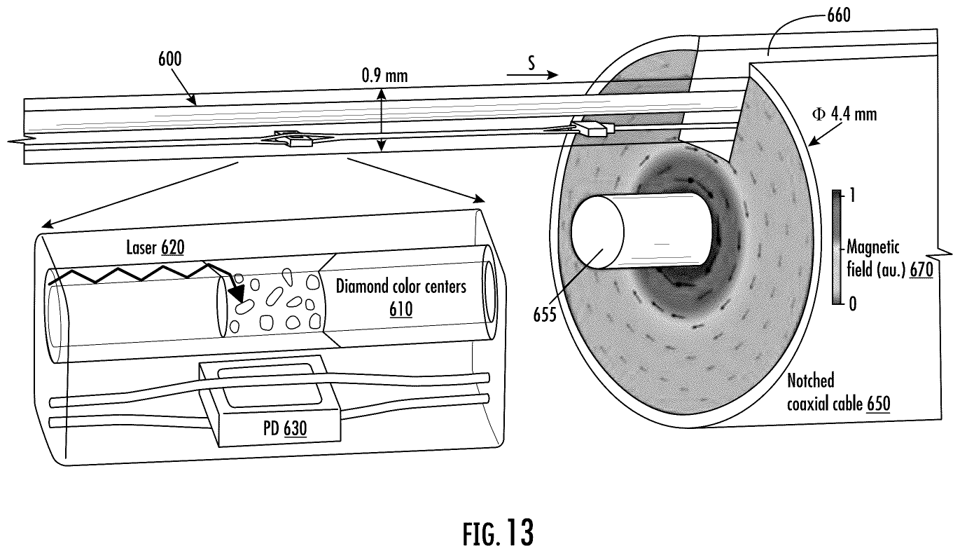

FIG. 13 shows another embodiment. In this embodiment, a silica hollow core waveguide 600 is employed. The silica hollow core waveguide 600 is coated with a polymer cladding. The overall diameter of this assembly may be about 0.9 mm. Diamond color centers 610 may be disposed in the hollow core of the waveguide 600. A laser source is coupled to the waveguide and provides laser light 620 that is used to excite the diamond color centers 610. Further, located near each diamond color center 610 may be a photodetector 630, such as a photodiode, for fluorescence collection.

A coaxial cable 650 is then notched in the radial direction to provide a recessed region 660 that is parallel to the inner core 655 of the coaxial cable 650. The waveguide assembly is then disposed in this recessed region 660. The waveguide assembly is preferable disposed close to the inner core 655, such as within 5 μm. A voltage may then be supplied to the inner core 655 of the coaxial cable 650. This voltage serves to generate a magnetic field 670 around the diamond color centers 610. While FIG. 13 shows diamond color centers, it is understood that other color centers may be utilized.

The present system has many advantages. FIGS. 1-4 and 5A-5B show two different approaches that allow high optical coupling efficiency (η). Further, the manufacturing processes are straightforward. Additionally, FIGS. 9-11 show different approaches that allow simple scaling to large numbers of waveguides coupled to as many fiber modes. Further, FIGS. 9-11 also allow the application of microwave fields for quantum memory spin control.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited t thereto and that the present disclosure may be beneficially implemented in any number of environments for any number of purposes. Accordingly, the claims set forth below should be construed in view of the full breadth and spirit of the present disclosure as described herein.

What is claimed is:

1. A method of coupling an optical fiber to a waveguide, the method comprising:
providing a single-mode fiber and a waveguide having a tapered end;
contacting the optical fiber to the waveguide to produce an interface; and
packaging the interface using a photo-polymerizable adhesive.

2. The method of claim 1, wherein an end of the optical fiber contacts the tapered end of the waveguide.

3. The method of claim 2, wherein the photo-polymerizable adhesive is cured by transmitting a curing light through the optical fiber.

4. The method of claim 3, wherein the curing light utilizes ultraviolet light.

5. The method of claim 3, wherein the photo-polymerizable adhesive comprises a two-photon polymerizable (2PP) resin, and the curing light utilizes infrared light.

6. The method of claim 2, wherein the tapered end of the waveguide has a width of between 40 nm and 60 nm.

7. The method of claim 2, wherein the photo-polymerizable adhesive has an index of refraction within 10% of the index of refraction of the optical fiber.

8. The method of claim 1, wherein the waveguide comprises a diamond waveguide.

9. A method of scalably coupling an optical fiber to a waveguide chiplet, the method comprising:
providing a fiber-bundle having a plurality of cores or hollow cores, and a waveguide chiplet having a plurality of waveguides;
coupling each core or hollow core of the fiber-bundle to a tapered end of a respective waveguide of the waveguide chiplet to produce a plurality of interfaces; and
packaging the plurality of interfaces using a photo-polymerizable adhesive.

10. The method of claim 9, wherein the fiber-bundle comprises a plurality of cores, wherein each core is tapered and each tapered core is coupled to a respective waveguide.

11. The method of claim 9, wherein an end of each core is coupled to the tapered end of the respective waveguide.

12. The method of claim 11, wherein the photo-polymerizable adhesive is cured by transmitting a curing light through the optical fiber.

13. The method of claim 12, wherein the photo-polymerizable adhesive comprises a 2PP resin, and the curing light comprises infrared energy.

14. The method of claim 11, wherein the fiber-bundle has a plurality of cores surrounded by a cladding, the method further comprising selectively etching the cores such that ends of the cores are recessed from the cladding prior to the coupling.

15. The method of claim 11, further comprising:
etching a CMOS device to form an etched region; and
disposing the waveguide chiplet in the etched region, wherein the tapered ends of the waveguides overhang an edge of the CMOS device.

16. The method of claim 15, further comprising disposing a microwave antenna on a top surface of the CMOS device.

17. A packaged device, comprising:
a CMOS device having an etched region;
a waveguide chiplet, comprising a plurality of waveguides, each having a tapered end, disposed in the etched region, wherein the tapered ends overhang an edge of the CMOS device; and
a fiber comprising a plurality of cores or hollow cores;
wherein a respective tapered end is coupled to an end of a respective core or hollow core to form a plurality of interfaces;
wherein the CMOS device, the waveguide chiplet and the plurality of interfaces are disposed in a package having a plurality of leads.

18. The packaged device of claim 17, further comprising a microwave antenna disposed on a surface of the CMOS device, and wherein RF signals are passed to the microwave antenna via one or more of the plurality of leads.

19. The packaged device of claim 17, wherein the tapered ends are coupled to the respective cores or hollow cores using a photo-polymerizable adhesive.

20. The packaged device of claim 17, further comprising a spring to stabilize the interfaces between the tapered ends and the respective cores or hollow cores.
